(19) United States
(12) Patent Application Publication
(10) Pub. No.: US 2017/0146140 A1
(43) Pub. Date: May 25, 2017

(54) CHECK VALVE

(71) Applicant: MANDO CORPORATION, Pyeongtaek-si (KR)

(72) Inventor: In-Wook JEON, Seoul (KR)

(21) Appl. No.: 15/355,601

(22) Filed: Nov. 18, 2016

(30) Foreign Application Priority Data
Nov. 19, 2015 (KR) 10-2015-0162346

(51) Int. Cl. F16K 15/04; B60T 8/34; F16K 27/02

(52) U.S. Cl. CPC F16K 15/044; F16K 27/0245; B60T 8/341

(57) ABSTRACT

A check valve is disclosed. The check valve installed in a bore of a modulator block having an inlet path and an outlet path and configured to control oil to flow in one direction, the check valve comprising: a valve housing which is installed in the bore and has an inlet and an outlet respectively configured to communicate with the inlet path and the outlet path, and of which an upper portion of the valve housing is open; a seat member which is installed in the valve housing and in which an orifice is formed; an opening and closing member provided to move forward or backward in the valve housing and configured to open or close the orifice; a guide part installed in the valve housing and configured to guide movement of the opening and closing member; a spring configured to press the opening and closing member toward the orifice; and a cap part configured to seal the open upper portion of the valve housing and fixed to the modulator block.

### CROSS-REFERENCE TO RELATED APPLICATION

This application claims the benefit of Korean Patent Application No. 2015-0162346, filed on Nov. 19, 2015 in the Korean Intellectual Property Office, the disclosure of which is incorporated herein by reference.

### BACKGROUND

1. Field

Embodiments of the present disclosure relate to a check valve, and more particularly, to a check valve provided at a hydraulic path of an electronically controlled brake system to control a flow of oil to be in only one direction.

2. Description of the Related Art

In general, a brake system is for efficiently preventing a slip phenomenon of a wheel which can occur when a vehicle is braked, suddenly started, or rapidly accelerated, and is configured to control braking pressure by a plurality of solenoid valves configured to control a braking pressure transferred from a master cylinder to a wheel cylinder and a plurality of check valves for preventing oil backflow being installed in a modulator block having a path forming a hydraulic circuit. Recently, electronically controlled brake systems, in which a hydraulic pressure supply apparatus configured to receive a braking will of a driver as an electrical signal from a pedal displacement sensor configured to sense a displacement of a brake pedal when the driver steps on the brake pedal and transfer the signal to a wheel cylinder, have been used. A structure of such an electronically controlled brake system is disclosed in Korean Laid-Open Patent No. 10-2013-0092045. According to the disclosed document, an electronically controlled brake system, in which a hydraulic pressure supply apparatus is provided, operates a motor according to a braking effort of a brake pedal and generates braking pressure. Here, the brake pressure is generated by converting a rotational force of the motor into a linear motion and pressing a piston.

Check valves are installed at proper places at a path formed in a modulator block as described above for controlling a flow of oil to be in one direction. For example, the check valves are installed at a path which connects a pressure supply apparatus and a reservoir, a path connected to each inlet valve of a hydraulic circuit, and the like.

As is well known, each of the check valves includes, a valve housing, a ball configured to open or close an oil path provided in the valve housing, an elastic member configured to elastically support the ball, a retainer or cap part configured to prevent the elastic member from escaping, and the like so that oil flows in only one direction.

However, since each part of a conventional check valve is manufactured through injection molding and press forming, there is a problem in that manufacturing is difficult and a process cost increases. In addition, since a forcible press fitting process is required for each part when the check valve is installed in the modulator block in addition to an increase in a product size, there is a problem in that precise installation and management are difficult.

Meanwhile, although each check valve installed in the modulator block has to perform a function of preventing oil backflow and a function of passing a sufficient amount of oil in a forward direction according to an installation position thereof and a purpose of use, an amount of oil which can pass through the check valves is fixed in a case in which the check valves have the same size, and thus there is a problem in that a required amount of oil is not supplied. Accordingly, there is an inconvenience in that bores are separately manufactured or separate check valves are manufactured and used for supplying the required amount of oil.

### PRIOR ART DOCUMENT

### Patent Document

(Patent Document) Korea Laid-Open Patent No. 10-2013-0092045 (MANDO CORP. Aug. 20, 2013.)

### SUMMARY

Therefore, it is an aspect of the present disclosure to provide a check valve having a simplified structure and manufactured with a low cost process so that a manufacturing cost thereof is decreased.

In addition, it is another aspect of the present disclosure to provide a check valve having the same shape and size of parts even when a size of an orifice changes so that the parts are sharable and manufactured as a single finished assembly to ensure ease of manufacturing thereof.

Additional aspects of the disclosure will be set forth in part in the description which follows and, in part, will be obvious from the description, or may be learned by practice of the disclosure.

In accordance with one aspect of the present invention, there is provided a check valve installed in a bore of a modulator block having an inlet path and an outlet path and configured to control oil to flow in one direction, the check valve comprising: a valve housing which is installed in the bore and has an inlet and an outlet respectively configured to communicate with the inlet path and the outlet path, and of which an upper portion of the valve housing is open; a seat member which is installed in the valve housing and in which an orifice is formed; an opening and closing member provided to move forward or backward in the valve housing and configured to open or close the orifice; a guide part installed in the valve housing and configured to guide movement of the opening and closing member; a spring configured to press the opening and closing member toward the orifice; and a cap part configured to seal the open upper portion of the valve housing and fixed to the modulator block.

Also, a step configured to support a lower portion of the seat member is formed in the valve housing; and the step is formed between the inlet and the outlet.

Also, the guide part includes a guide hole formed to pass through a center thereof; and the guide hole has a diameter greater than that of the opening and closing member.

Also, the guide hole is provided to have a large diameter portion configured to guide the opening and closing member and a small diameter portion having a diameter smaller than that of the opening and closing member; and a movement range of the opening and closing member is restricted by the small diameter portion.

Also, the small diameter portion is provided to guide the spring.

Also, a plurality of communication holes configured to communicate with the outlet through the guide hole when the opening and closing member opens the orifice are formed around the guide part.

Also, the check valve is provided as a single assembly; and the seat member, the opening and closing member, the guide part, and the spring are selectively changeable according to a required amount of passing oil.

Also, a diameter of the orifice of the seat member, a diameter of the opening and closing member, a diameter of the guide hole of the guide part, and a size of the spring are selectively changed according to a use and an installation position of the check valve to supply a flow of a required amount of oil.

Also, the opening and closing member is formed as a ball in a spherical shape.

Also, the guide part is formed by injection molding.

Also, the seat member is formed by a forging process.

Also, the valve housing is formed by a press forming process.

Also, the guide part and the cap part are integrally formed.

### BRIEF DESCRIPTION OF THE DRAWINGS

FIG. 1 is an exploded perspective view illustrating a state in which a check valve according to one exemplary embodiment of the present disclosure is assembled in a modulator block.

FIG. 2 is a perspective view of an assembly of FIG. 1.

FIG. 3 is a cross-sectional view illustrating the check valve.

FIG. 4 is a cross-sectional view illustrating operation state of the check valve.

FIG. 5 is a cross-sectional view illustrating a check valve according to another exemplary embodiment of the present disclosure.

### DETAILED DESCRIPTION

Hereinafter, embodiments of the present disclosure will be described in detail with reference to the accompanying drawings. The embodiments are provided in order to fully explain the spirit and scope of the present disclosure to those skilled in the art. Thus, the present disclosure is not to be construed as limited to the embodiments set forth herein and may be accomplished in other various embodiments. Parts irrelevant to the description are omitted in the drawings in order to clearly explain the present disclosure. Sizes of elements in the drawings may be exaggerated in order to facilitate understanding.

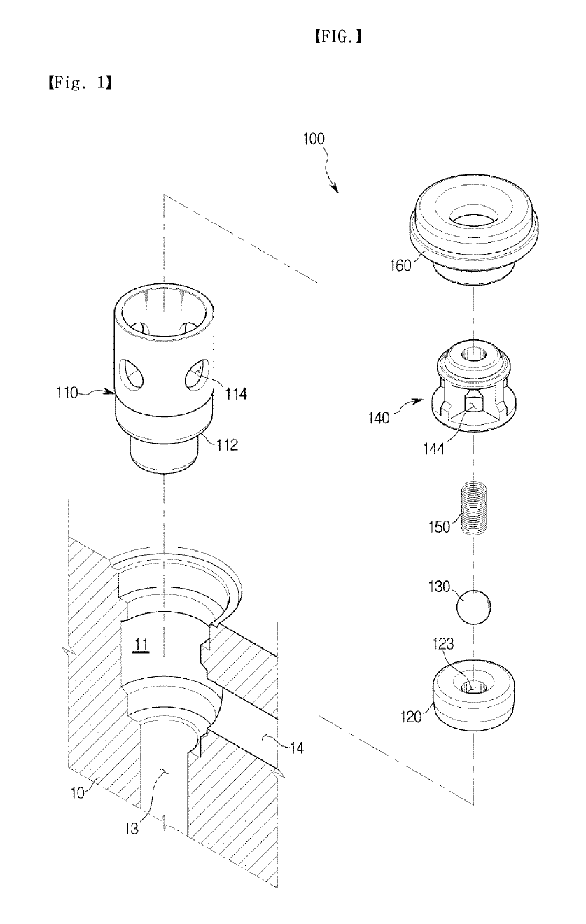

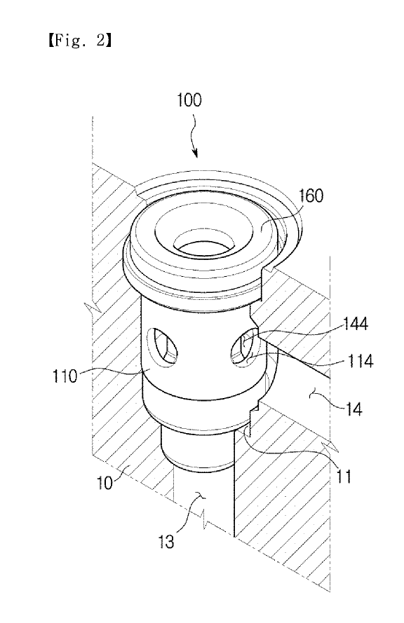

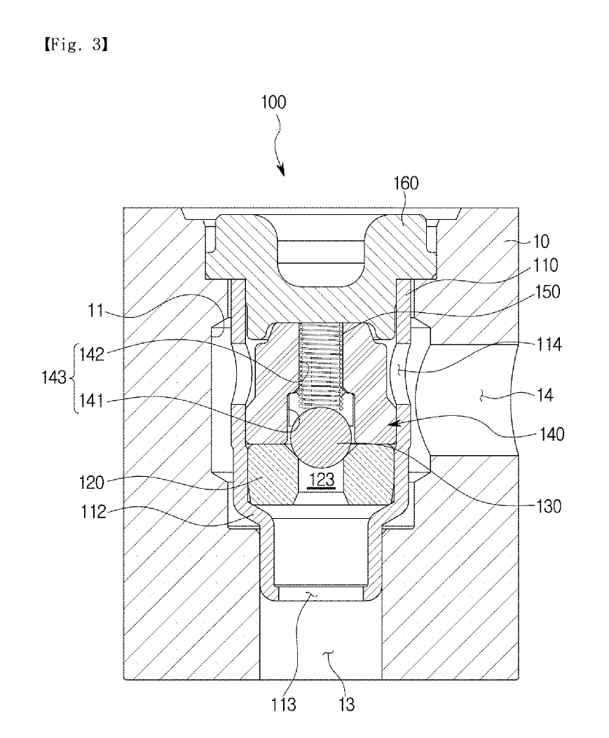

FIG. 1 is an exploded perspective view illustrating a state in which a check valve according to one exemplary embodiment of the present disclosure is assembled in a modulator block, FIG. 2 is a perspective view of an assembly of FIG. 1, and FIG. 3 is a cross-sectional view illustrating the check valve.

Referring to FIGS. 1 to 3, a check valve 100 includes a valve housing 110 having an inlet 113 and outlets 114, a seat member 120 installed in the valve housing 110 and having an orifice 123, an opening and closing member 130 provided to move forward or backward in the valve housing 110 to open or close the orifice 123, a guide part 140 installed in the valve housing 110 to guide the movement of the opening and closing member 130, a spring 150 configured to press the opening and closing member 130 toward the orifice 123, and a cap part 160 configured to seal an open upper portion of the valve housing 110. The check valve 100 is installed in a bore 11 formed in a modulator block 10 to prevent oil backflow and is configured to control oil to flow in one direction.

The valve housing 110 has a cylindrical shape of which the upper portion is open, and the inlet 113 and the outlets 114 respectively configured to communicate with an inlet path 13 and an outlet path 14 formed in the modulator block 10 are formed in the valve housing 110. Here, the valve housing 110 is installed in the bore 11, and the inlet 113 and the outlets 114 are formed to respectively correspond to positions at which the inlet path 13 and the outlet path 14 are formed. More specifically, the valve housing 110 is formed to be stepped to support a lower end of the seat member 120, which will be described below. Accordingly, the seat member 120 is supported by a step 112 of the valve housing 110 which is stepped. Here, the step 112 is formed between the inlet 113 and the outlets 114. As illustrated in the drawings, the inlet 113 is formed at a lower portion of the valve housing 110, and the outlets 114 are formed at a perimeter of the valve housing 110. The valve housing 110 may be manufactured by a press process.

As described above, the seat member 120 is installed at the step 112 in the valve housing 110. As the seat member 120 is installed at the step 112, the inlet 113 communicates with the outlets 114 through the orifice 123 formed in the seat member 120 and positioned between the inlet 113 and the outlets 114. The seat member 120 may be manufactured by a forging process.

The opening and closing member 130 is provided to move forward or backward in the valve housing 110 and perform a function of opening or closing the orifice 123 provided between the inlet 113 and the outlets 114. That is, the orifice 123 is opened or closed to control a flow of oil. Here, the opening and closing member 130 may be formed as a ball in a spherical shape as illustrated in the drawings. Here, a diameter of the ball 130 is greater than that of the orifice 123 to close the orifice 123. The opening and closing member 130 is provided in a state in which the orifice 123 is closed by being pressed by the spring 150 which will be described below.

The guide part 140 is installed in the valve housing 110 to guide the movement of the opening and closing member 130. More specifically, the guide part 140 includes a guide hole 143 having a cylindrical shape and formed by passing through a center of the guide part 140 to open upper and lower portions thereof, and a plurality of communication holes 144 formed therearound to communicate with the guide hole 143. Here, the guide part 140 is disposed so that the guide hole 143 faces the orifice 123 and is installed to be in contact with the seat member 120.

The guide hole 143 may be formed to have a diameter greater than that of the opening and closing member 130 to guide the movement of the opening and closing member 130. Referring to the drawings, the guide hole 143 includes a large diameter portion 141 provided to have a diameter greater than the opening and closing member 130 to guide the opening and closing member 130, and a small diameter portion 142 having a diameter smaller than the opening and closing member 130. Accordingly, a movement range of the opening and closing member 130 is restricted by the small diameter portion 142. Since the guide hole 143 guides the movement of the opening and closing member 130, moving stability and reactivity thereof can be improved.

The plurality of communication holes 144 are formed along a perimeter of the guide part 140 to be spaced a predetermined distance from each other. Accordingly, the communication holes 144 enable the outlets 114 to communicate with the orifice 123 through the guide hole 143 when the opening and closing member 130 opens the orifice 123 and enable oil to flow. Here, since the communication holes 144 are provided at positions facing the outlets 114, oil which passed through the orifice 123 is discharged through a side surface of the guide part 140 through the outlets 114, and thus flow resistance of the oil can be minimized.

Meanwhile, the guide part 140 may be manufactured through injection molding.

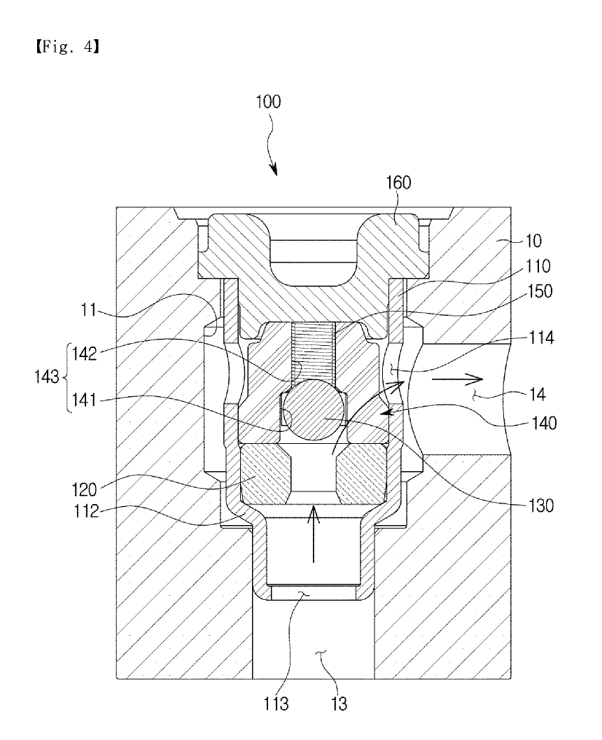

The spring 150 is disposed in the guide part 140 to press the opening and closing member 130 toward the orifice 123. That is, the opening and closing member 130 comes into contact with the orifice 123 and the flow of oil is blocked, that is, oil backflow is prevented. Accordingly, as the opening and closing member 130 compresses the spring 150 with pressure of oil introduced through the inlet 113 and moves along the guide hole 143, the orifice 123 is opened (see FIG. 4). In addition, when the flow of oil is blocked, that is, the pressure of the oil introduced through the inlet 113 is less than an elastic force of the spring 150, or a pressure is generated from the outlets 114, the opening and closing member 130 closes the orifice 123 to prevent oil backflow. As the spring 150 is installed so that a part thereof is inserted into the guide hole 143, that is, into the small diameter portion 142, the spring 150 is prevented from escaping. Here, although one end of the spring 150 is described as being supported by the opening and closing member 130, and the other end is described as being supported by the cap part 160, which will be described below, the present disclosure is not limited thereto, and the other end of the spring 150 may also be provided to be supported by the guide part 140.

The cap part 160 seals the open upper portion of the valve housing 110 and is fixed to the modulator block 10. Here, the cap part 160 is inserted into the open upper portion of the valve housing 110 and is installed to be in contact with the guide part 140. Accordingly, the cap part 160 maintains a firm coupling state of the guide part 140 and supports the other end of the spring 150 through the open upper portion of the guide part 140. Meanwhile, although the cap part 160 is illustrated as being inserted into the upper portion of the guide part 140, the present disclosure is not limited thereto, and the upper portion of the valve housing 110 may also be coupled to the cap part 160 so that valve housing 110 is inserted into the cap part 160.

In addition, the cap part 160 and the guide part 140 may be integrally formed unlike the drawings.

The above-described check valve 100 may be formed as a single assembly. That is, the seat member 120 is pressed at and fixed to the step 112 in the valve housing 110, the opening and closing member 130 is positioned to be in contact with the orifice 123, the guide part 140 and the spring 150 are installed therein, the cap part 160 is coupled thereto, and then a single finished product is manufactured. Accordingly, since the check valve 100 may be installed on the outside of the modulator block 10 as a finished product, mass-productivity is improved and ease of manufacturing and assembly is achieved in comparison to a conventional process in which each part of a check valve is individually installed to install the check valve.

The check valve 100 according to the embodiment of the present disclosure may be provided to be selectively changed according to a use and an installation position thereof so that a required amount of oil flows. For example, in a brake system, there is a difference between required amounts of oil which pass through a check valve installed at a path connected to a wheel cylinder through a hydraulic circuit and a check valve installed to supply oil to a pressure supply apparatus. Accordingly, the check valve 100 according to the embodiment of the present disclosure is provided to supply a required amount of oil by changing a size of the orifice 123 through which the oil passes while the orifice 123 maintains the same shape and size. That is, since the required amount of oil is supplied by changing the seat member 120, the opening and closing member 130, the guide part 140, and the spring 150 installed in the valve housing 110, parts can be shared and a degree of design freedom for the orifice 123 can also be improved.

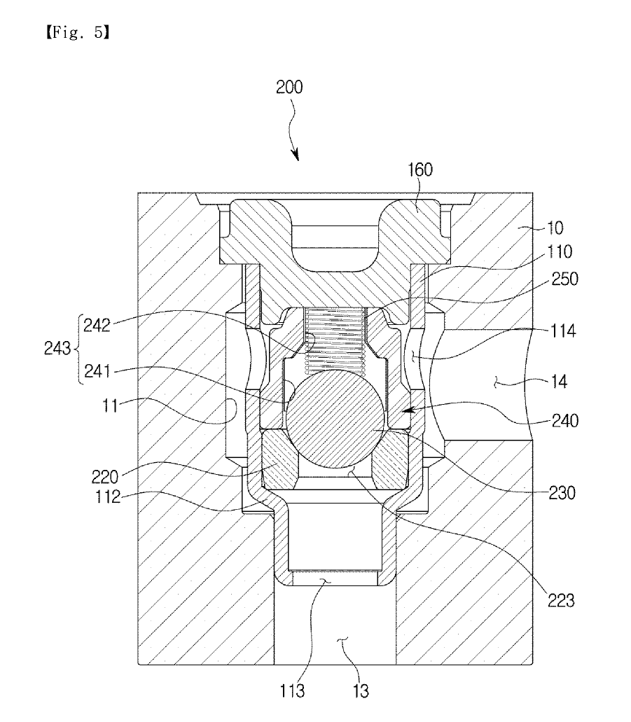

A check valve 200 in which a size of an orifice 223 is changed according to a required amount of oil described above is illustrated in FIG. 5. FIG. 5 is a cross-sectional view illustrating a check valve according to another exemplary embodiment of the present disclosure. Here, the same reference numerals as those of the previous drawings denote members having the same functions.

Referring to FIG. 5, the check valve 200 according to the present embodiment includes a valve housing 110 having an inlet 113 and outlets 114, a seat member 220 which is installed in the valve housing 110 and in which the orifice 223 is formed, an opening and closing member 230 provided to move forward or backward in the valve housing 110 to open or close the orifice 223, a guide part 240 in which a guide hole 243 having a large diameter portion 241 configured to guide the movement of the opening and closing member 230 and a small diameter portion 242 configured to restrict the movement of the opening and closing member 230 are formed is installed in the valve housing 110, a spring 250 configured to press the opening and closing member 230 toward the orifice 223, and a cap part 160 configured to seal an open upper portion of the valve housing 110. Here, outer circumferential shapes of the valve housing 110, the seat member 220, the guide part 240, and the cap part 160 are the same as those of the previous embodiment.

More specifically, a diameter of the orifice 223 of the seat member 220 is provided to be greater than that of the orifice 123 illustrated in FIG. 3. For example, the diameter of the orifice 123 illustrated in FIG. 3 is 1. 8φ, and the diameter of the orifice 223 according to the embodiment of the present disclosure is 3φ. Accordingly, a diameter of the opening and closing member 230 configured to open or close the orifice 223 is greater than that of the opening and closing member 130 according to the previous embodiment in accordance with the diameter orifice 223. In addition, as the diameter of the opening and closing member 230 increases, a diameter of the guide hole 243 of the guide part 240 which guides the opening and closing member 230 and a diameter of the spring 250 which elastically supports the opening and closing member 230 increases. However, as described above, since external shapes of the seat member 220 and the guide part 240 are the same as those of the previous embodiment, shapes and sizes of the check valve 200 are not changed in comparison to the check valve 100, but a difference in an amount of oil flowing through the check valve 200 occurs. That is, as a size of the orifice 223 increases, an amount of oil increases, and thus a required amount of oil can be supplied.

As is apparent from the above description, in a check valve according to one embodiment of the present disclosure, there are effects in that ease of assembly process can be achieved since an integrated check valve is assembled at the outside as well as mass-productivity is excellent since the check valve is manufactured as a single finished assembly product.

In addition, a manufacturing cost can be decreased by simplifying a structure and manufacturing a guide part and a valve housing through low cost injection molding and press forming processes.

In addition, there are effects in that a degree of design freedom for an orifice is improved as well as parts can be shared even when a size of the orifice changes since a check valve is provided to have the same shape and size. Accordingly, a required amount of oil can be supplied according to an installation position and a purpose of use.

Meanwhile, there are effects in that moving stability and reactivity can be improved by guiding a movement of an opening and closing member, and a flow of oil can be stably controlled because flow resistance decreases and a check valve is opened in a forward direction even under a low pressure.

As described above, although the present disclosure has been shown and described with respect to a few specific embodiments and drawings, those skilled in the art should appreciate that various modifications and changes may be made in the technical concept of the present disclosure, the scope of which is defined in the claims and their equivalents.

[Reference Numerals]

| 100, 200: CHECK VALVE | 110: VALVE HOUSING |
|---|---|
| 120, 220: SEAT MEMBER | 123, 223: ORIFICE |
| 130, 230: OPENING AND CLOSING MEMBER | |
| 140, 240: GUIDE PART | 143, 243: GUIDE HOLE |
| 144: COMMUNICATION HOLE | |
| 150, 250: SPRING | 160: CAP PART |

What is claimed is:

1. A check valve installed in a bore of a modulator block having an inlet path and an outlet path and configured to control oil to flow in one direction, the check valve comprising:
a valve housing which is installed in the bore and has an inlet and an outlet respectively configured to communicate with the inlet path and the outlet path, and of which an upper portion of the valve housing is open;
a seat member which is installed in the valve housing and in which an orifice is formed;
an opening and closing member provided to move forward or backward in the valve housing and configured to open or close the orifice;
a guide part installed in the valve housing and configured to guide movement of the opening and closing member;
a spring configured to press the opening and closing member toward the orifice; and
a cap part configured to seal the open upper portion of the valve housing and fixed to the modulator block.

2. The check valve of claim 1, wherein:
a step configured to support a lower portion of the seat member is formed in the valve housing; and
the step is formed between the inlet and the outlet.

3. The check valve of claim 1, wherein:
the guide part includes a guide hole formed to pass through a center thereof; and
the guide hole has a diameter greater than that of the opening and closing member.

4. The check valve of claim 3, wherein:
the guide hole is provided to have a large diameter portion configured to guide the opening and closing member and a small diameter portion having a diameter smaller than that of the opening and closing member; and
a movement range of the opening and closing member is restricted by the small diameter portion.

5. The check valve of claim 4, wherein the small diameter portion is provided to guide the spring.

6. The check valve of claim 3, wherein a plurality of communication holes configured to communicate with the outlet through the guide hole when the opening and closing member opens the orifice are formed around the guide part.

7. The check valve of claim 3, wherein:
the check valve is provided as a single assembly; and
the seat member, the opening and closing member, the guide part, and the spring are selectively changeable according to a required amount of passing oil.

8. The check valve of claim 7, wherein a diameter of the orifice of the seat member, a diameter of the opening and closing member, a diameter of the guide hole of the guide part, and a size of the spring are selectively changed according to a use and an installation position of the check valve to supply a flow of a required amount of oil.

9. The check valve of claim 1, wherein the opening and closing member is formed as a ball in a spherical shape.

10. The check valve of claim 1, wherein the guide part is formed by injection molding.

11. The check valve of claim 1, wherein the seat member is formed by a forging process.

12. The check valve of claim 1, wherein the valve housing is formed by a press forming process.

13. The check valve of claim 1, wherein the guide part and the cap part are integrally formed.
